(19) United States
(12) Patent Application Publication
(10) Pub. No.: US 2016/0137035 A1
(43) Pub. Date: May 19, 2016

(54) APPARATUS AND METHOD FOR RESTRAINING MICROBIAL PROPAGATION ON A SURFACE OF AN EVAPORATOR FOR VEHICLE

(71) Applicant: Hyundai Motor Company, Seoul (KR)

(72) Inventors: Ki Young Yoon, Seoul (KR); Jae Sik Choi, Gyeonggi-do (KR); Tae Hee Lee, Gyeonggi-Do (KR); Ji Wan Kim, Gyeonggi-Do (KR); So Yoon Park, Seoul (KR)

(21) Appl. No.: 14/863,983

(22) Filed: Sep. 24, 2015

(30) Foreign Application Priority Data
Nov. 13, 2014 (KR) 10-2014-0157814

(51) Int. Cl. B60H 3/00

(52) U.S. Cl. CPC B60H 3/0092

(57) ABSTRACT

An apparatus and a method of restraining microbial propagation on the surface of an evaporator of an automotive air conditioning system include a blower for generating airflow, an evaporator (evaporator core) for cooling, a heater core through which an engine coolant passes for heating, a temperature control door, an internal/external air mode door, a mode door, and a controller for controlling these components, in which microbial propagation can be prevented by heating the evaporator using the heat of the heater core only by controlling the operation of the temperature control door without any additional component.

### CROSS-REFERENCE TO RELATED APPLICATION

This application claims under 35 U.S.C. §119(a) the benefit of Korean Patent Application No. 10-2014-0157814 filed on Nov. 13, 2014, the entire contents of which are incorporated herein by reference.

### BACKGROUND

(a) Technical Field

The present invention relates to an apparatus and a method of restraining microbial propagation on the surface of an evaporator of an automotive air conditioning system. More particularly, it relates to an apparatus and a method of restraining microbial propagation on the surface of an evaporator that can cause a bad odor or stink from an air conditioner.

(b) Description of the Related Art

A bad odor or stink from an air conditioner is a chronic problem with the quality of vehicles and is usually caused by MVOCS (Microbial Volatile Organic Compounds) produced by metabolism of microorganisms on the surface of an evaporator (evaporator core) of an air conditioner.

Technologies of applying an antimicrobial, radiating ultraviolet rays, or producing negative ions have been used to prevent microbial propagation on the surface of an evaporator core, but a bad odor or stink in a vehicle due to an air conditioner still remains as an unsolved problem.

In the automotive air conditioning systems, an evaporator for cooling and a heater core for heating are arranged opposite each other. The temperature of the heater core is maintained at a high temperature of 80° C. due to a high-temperature coolant from an engine when a vehicle is running In contrast, the surface temperature of the evaporator drops to about 4° C. due to evaporation of a coolant compressed by a compressor that is operated when the air conditioner is turned on.

Air flowing in an air conditioning system passes an evaporator through a filter and a blower, and a temperature at the exit depends on a temperature control door between the evaporator and a heater core.

FIG. 1 (RELATED ART) illustrates an example of a temperature control door for controlling a heater core and an evaporator and airflow between them in an air conditioning system.

As illustrated in FIG. 1, a temperature control door is rotatably disposed between an evaporator and a heater core and the amount of air to pass through the heater core of the air that has passed through the evaporator depends on the rotation angle of the temperature control door.

In particular, as illustrated in FIG. 2A (RELATED ART), when a desired temperature is set for maximum cooling, the temperature control door is rotated to close the heater core and completely blocks air flowing into the heater core after having passed through the evaporator.

On the contrary, as illustrated in FIG. 2B (RELATED ART), when a desired temperature is set for maximum heating, the temperature control door is rotated to open the heater core and fully open to allow all of the air to pass through the heater core.

On the other hand, when a desired temperature is set at a specific temperature (for example, 23° C.), the temperature control door is opened, as shown in FIG. 1, appropriately to control the internal temperature of a vehicle at the desired temperature.

When the air conditioning system is turned off or the engine is stopped with a vehicle in motion, the temperature control door stops the operation at the position at that time.

In this state, a bad odor or stink is produced by metabolism of microorganisms on the surface of the evaporator.

The above information disclosed in this Background section is only for enhancement of understanding of the background of the invention and therefore it may include information that does not form the prior art that is already known in this country to a person of ordinary skill in the art.

### SUMMARY

The present invention provides an apparatus and a method of restraining microbial propagation by heating an evaporator using the heat of a heater core only by controlling the operation of a temperature control door without any additional component.

In one aspect, the present invention provides an apparatus for restraining microbial propagation on the surface of an evaporator of an automotive air conditioning system of a vehicle, which includes: an evaporator and a heater core disposed in the automotive air conditioning system of the vehicle; a temperature control door disposed between the evaporator and the heater core so as to selectively block air flowing into the heater core; and a controller controlling opening/closing of the temperature control door, in which when an engine of the vehicle is stopped, the controller opens the temperature control door so that air can flow between the evaporator and the heater core.

In a preferred embodiment, the controller may fully open the temperature control door when the engine of the vehicle is stopped.

In another preferred embodiment, the controller may determine an expected parking time, and open the temperature control door only when the determined expected parking time is over a predetermined reference time.

In still another preferred embodiment, the controller may receive a parking time from a switch and determine the received parking time as the expected parking time.

In yet another preferred embodiment, the controller may keep parking time data set for each time zone and determine parking time data for a point of time when the engine is stopped as the expected parking time.

In still yet another preferred embodiment, the controller may learn a parking pattern by matching parking time with information such as positions provided from a GPS, a date, and time and estimate the expected parking time on the basis of the learned parking pattern.

In a further preferred embodiment, when the engine is started again and the automotive air conditioning system is operated within the predetermined reference time, the controller may discharge wind down to the floor for a predetermined time.

In another aspect, the present invention provides an apparatus for restraining microbial propagation on the surface of an evaporator of an automotive air conditioning system of a vehicle, which includes: an evaporator and a heater core disposed in the automotive air conditioning system of the vehicle; a temperature control door disposed between the evaporator and the heater core so as to selectively block air flowing into the heater core; and a controller controlling opening/closing of the temperature control door, in which when the automotive air conditioning system is turned off while the vehicle is running, the controller opens the temperature control door so that air can flow between the evaporator and the heater core.

In a preferred embodiment, when the automotive air conditioning system is turned off, the controller may convert an internal/external air mode door into an internal air mode.

In another preferred embodiment, the controller may receive information on a temperature of external air, and may open the temperature control door only when the temperature of the external air is under a predetermined reference temperature.

In still another preferred embodiment, when the automotive air conditioning system may be operated again before a predetermined opening time, the controller may discharge wind down to the floor for a predetermined time.

In still another aspect, the present invention provides a method of restraining microbial propagation on the surface of an evaporator of an automotive air conditioning system of a vehicle, which includes: sensing whether an engine of a vehicle has been stopped by a controller; and opening a temperature control door, which is disposed between an evaporator and a heater core in an air conditioning system so that air can flow between the evaporator and the heater core, when the engine is stopped by the controller.

In a preferred embodiment, the method may further include determining an expected parking time and comparing the determined parking time with a predetermined reference time, by the controller, before the opening of a temperature control door, in which in the opening of a temperature control door, the temperature control door may open only when the determined expected parking time is over a predetermined reference time.

In another preferred embodiment, the controller may receive a parking time from a switch and determine the received parking time as the expected parking time.

In still another preferred embodiment, the controller may keep parking time data set for each time zone and determine parking time data for the point of time when the engine is stopped as the expected parking time.

In yet another preferred embodiment, the controller may learn a parking pattern by matching parking time with information such as positions provided from a GPS, a date, and time and estimate an expected parking time on the basis of the learned parking pattern.

In still yet another preferred embodiment, the method may further include discharging wind down to the floor for a predetermined time, by the controller, when the engine is started again and the automotive air conditioning system is operated within the predetermined reference time.

In a further preferred embodiment, in the opening of the temperature control door, the temperature control door may be fully opened.

In a further aspect, the present invention provides a method of restraining microbial propagation on the surface of an evaporator of an automotive air conditioning system of a vehicle, which includes: sensing whether an engine of the vehicle has been stopped by a controller; and opening a temperature control door, which is disposed between an evaporator and a heater core in the automotive air conditioning system so that air can flow between the evaporator and the heater core, when the automotive air conditioning system is turned off while the vehicle is running, by the controller.

In a preferred embodiment, the method may further include changing an internal/external air mode door into an internal air mode after the air conditioning system is turned off, before the opening of the temperature control door.

In another preferred embodiment, the method may further include receiving information on a temperature of external air and comparing the received temperature of the external air with a predetermined reference temperature, before the opening of the temperature control door, by the controller, in which the temperature control door is opened only when the temperature of external air is under the predetermined reference temperature.

In still another preferred embodiment, the method may further include discharging wind down to the floor for a predetermined time, by the controller, when the automotive air conditioning system is operated again before a predetermined opening time.

According to the apparatus and the method of restraining microbial propagation on the surface of an evaporator of an automotive air conditioning system of the present invention, it is possible to thermally damage microorganisms on an evaporator core only by using a simple logic, with existing hardware kept.

It is also possible to remove nutriments for microorganisms by separating various gas-state substances that are the nutriments adsorbed to an evaporator core for propagation of microorganisms.

By thermally damaging microorganisms and removing nutriments, it is possible to minimize propagation of microorganisms on an evaporator core and reduce a stink due to microorganisms accordingly.

According to an exemplary embodiment of the present invention, since an expected parking time is determined, a microbial propagation restraint logic is executed only when a vehicle is parked for a long time over a predetermined time, and the direction of wind discharged from an air conditioning system is adjusted, so that it is possible to solve the problem that condensate water is discharged in a vapor state to a driver.

Other aspects and preferred embodiments of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 (RELATED ART) illustrates an example of a temperature control door for controlling a heater core and an evaporator and airflow between them in an air conditioning system;

FIGS. 2A and 2B (RELATED ART) illustrate an example of controlling the rotation amount of the temperature control door illustrated in FIG. 1;

FIG. 3 is shows an example of an apparatus for restraining microbial propagation on the surface of an evaporator of an automotive air conditioning system according to the present invention;

FIGS. 4A and 4B show rotation of a temperature control door for cooling/heating;

FIG. 5 is a flowchart illustrating a method of restraining microbial propagation on the surface of an evaporator of an automotive air conditioning system according to an exemplary embodiment of the present invention;

FIG. 6 is a flowchart illustrating a method of restraining microbial propagation on the surface of an evaporator of an automotive air conditioning system according to another exemplary embodiment of the present invention; and

FIG. 7 is a diagram illustrating the result of measuring temperature of an evaporator of an air conditioning system equipped with the apparatus for restraining microbial propagation according to the present invention.

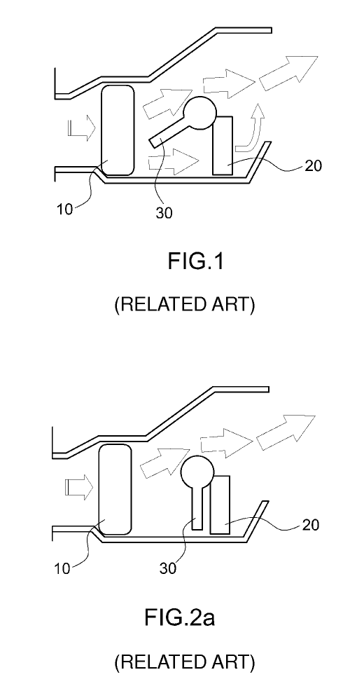

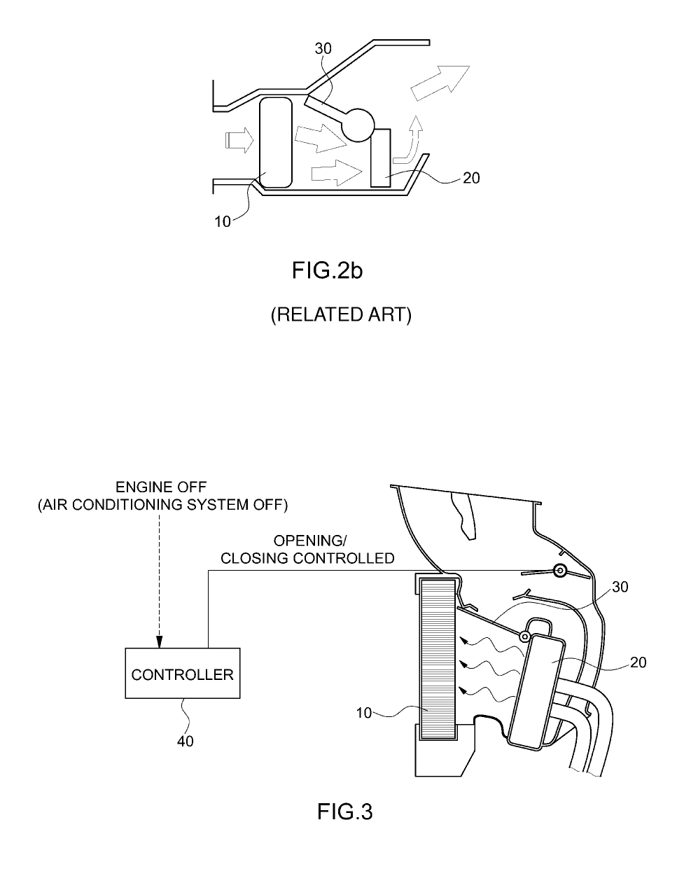

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

The present invention relates to an automotive air conditioning system for a vehicle with an internal combustion engine which includes an evaporator and a heater core and can restrain microbial propagation, and a method of controlling the automotive air conditioning system.

The automotive air conditioning system may include a blower for making airflow, an evaporator (evaporator core) for cooling, a heater core through which an engine coolant passes for heating, a temperature control door, an internal/external air mode door, a mode door, and a controller for controlling these components.

The components described herein should be construed as being examples selected for achieving the spirit of the present invention, not being limited to those proposed herein. For example, the temperature control door proposed herein only must be able to control airflow between the heater core and the evaporator and is not limited to the rotary plate-shaped structure illustrated in FIG. 3, and the like.

In particular, according to the present invention, when an engine is stopped, the temperature control door is moved to the position for maximum heating, that is, in order to fully open the heater core, and then stopped so that the heat of the heater core transfers to the evaporator.

Therefore, according to the present invention, the engine coolant is maintained at a high temperature for a long time even with the engine stopped, so the evaporator can be supplied with sufficient heat.

Hereinafter, an apparatus and a method of restraining microbial propagation on the surface of an evaporator of an automotive air conditioning system according to exemplary embodiments of the present invention will be described in detail with reference to the accompanying drawings.

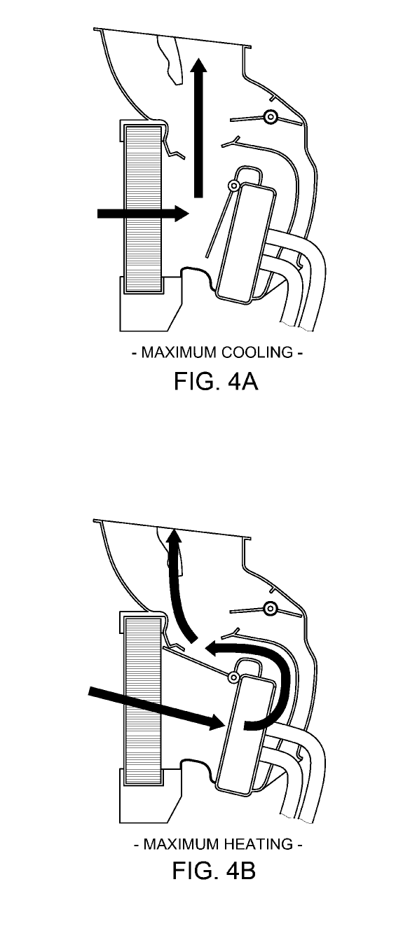

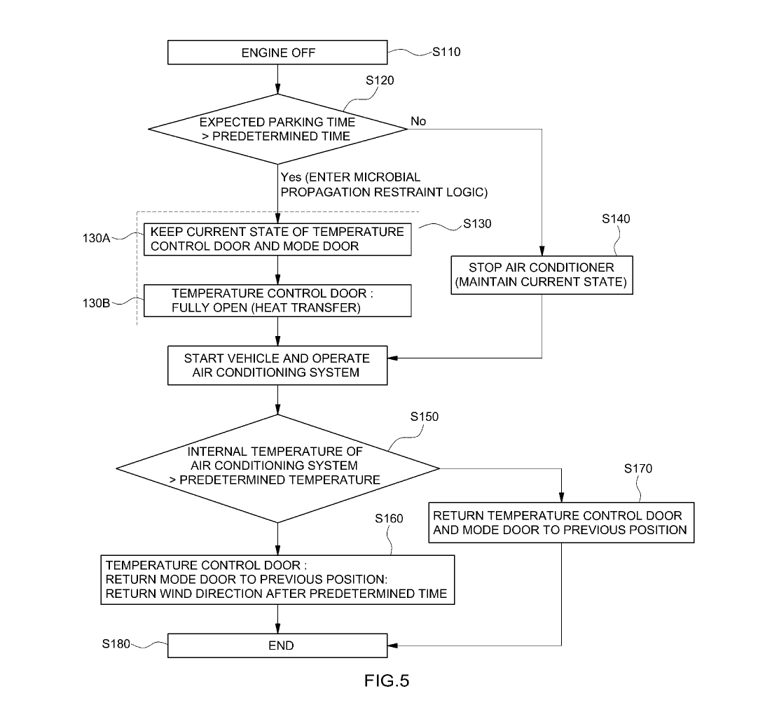

FIGS. 3 and 4 illustrate examples of an apparatus for restraining microbial propagation on the surface of an evaporator of an automotive air conditioning system according to the present invention.

As illustrated in FIG. 3, an apparatus for restraining microbial propagation on the surface of an evaporator of an automotive air conditioning system according to the present invention includes an evaporator and a heater core disposed in the automotive air conditioning system, and a temperature control door capable of controlling airflow between the evaporator and the heater core is disposed therebetween.

Referring to FIGS. 4A and 4B, air that has flowed in the air conditioning system and then passed through a filter (not shown) and a blower (not shown) flows into the evaporator, and then the air is discharged through (FIG. 4B) or not through (maximum heating in FIG. 4A) the heater core by the temperature control door rotating.

Referring to FIG. 3, the apparatus for restraining microbial propagation on the surface of an evaporator of an automotive air conditioning system according to the present invention includes a controller that controls opening/closing of the temperature control door, depending on whether an engine is stopped.

When the engine of a vehicle is stopped, the controller opens the temperature control door to allow for airflow between the evaporator and the heater core. Referring to FIG. 3, the temperature control door can be fully opened, and accordingly, heat transfer to the evaporator can be maximized.

As shown in FIG. 3, when an engine is stopped with the temperature control door fully open, airflow stops between the evaporator (4° C. to room temperature) and the heater core (over 80° C.) facing each other, so heat is transferred from the heater core to the evaporator by radiation and convection, and the surface temperature of the evaporator increases over 40° C., which is a temperature sufficient to restrain propagation of microorganisms on the surface of the evaporator by thermally damaging them.

In the apparatus for restraining microbial propagation on the surface of an evaporator of an automotive air conditioning system according to the present invention, when the operation state of the automotive air conditioning system before the engine is stopped is kept and the engine is restarted or the automotive air conditioning system is started again later, the temperature control door can be controlled to automatically find the previous position.

According to an exemplary embodiment of the present invention, the controller may determine and compare expected parking time with a predetermined time when an engine is stopped, and it can fully open and then stop the temperature control door only when a predetermined condition is satisfied. In general, it may be required to secure over three hours after the engine is stopped, in order to appropriately restrain microbial propagation due to heat transfer. If a driver re-starts the engine and the air conditioning system within a shorter time, microorganisms are not sufficiently exposed to high temperature and condensate water in the evaporator may make the driver unpleasant by moving in a vapor state directly to the driver.

In order to prevent such a problem, in the exemplary embodiment, the controller is designed to determine an expected parking time and then determine whether to enter a logic for restraining microbial propagation on the basis of the expected parking time, before entering a logic.

Examples of a method for determining an expected parking time are as follows.

(1) Determining an Expected Parking Time on the Basis of Input through a Switch

According to this method, a driver lets a controller know the fact that a vehicle will be parked for a long time, by manually operating a specific switch.

The specific switch for inputting parking time is mounted on an automotive air conditioning system and a parking time inputted through the switch is determined as an expected parking time.

For example, the switch may be an air conditioner sterilization button, and when a vehicle will be parked for a long period of time, the driver executes a microbial propagation restraint logic by pressing the button.

(2) Using Expected Parking Time Data Set in Advance or each Time Zone

According to this method, a manufacturer statistically sets in advance time zones in which a vehicle is expected to be parked for a long time. For example, longtime parking may be set for the range from 6:00 pm in one day until 9:00 am the next day, and short-time parking may be set for the range from 9:00 am to 6:00 pm. Obviously, the time zones may be designed to be changed by a driver.

Therefore, the controller keeps parking time data set for each time zone and determines the parking time data corresponding to the point of time when an engine is stopped, as an expected parking time.

(3) Determining an Expected Parking Time on the Basis of Learned parking Patterns

According to this method, a controller is designed to learn parking patterns of a user by matching parking time with information such as positions provided from a GPS or date/time and estimate parking time.

In spite of such a logic, there is still a possibility of making a driver uncomfortable due to restarting of an engine within a short time after parking, so the controller may be configure to adjust the direction of wind to solve this problem.

In particular, in such an example, in order to prevent hot and humid air from being discharged to the face of the driver when the engine is restarted within a short time, the controller is designed to allow the driver to freely set the direction of wind after discharging hot air downward for a predetermined time.

When the engine is restarted or the automotive air conditioning system is operated and the internal temperature of the air conditioning system is over a predetermined temperature, the direction of the wind may be designed to be adjusted down to the floor.

According to another exemplary embodiment of the present invention, a temperature control door may be controlled similarly in a vehicle that is running.

In particular, when the entire air conditioning system including not only an air conditioner, but a blower is turned off with a vehicle in motion, a temperature control door may be fully opened so that heat of a heater core can smoothly transfer to an evaporator. The temperature control door may be opened, with wind prevented from flowing inside by converting an internal/external air mode door in an internal air mode before the temperature control door opens.

In the exemplary embodiment, the temperature of external air may be considered as a factor for determination to execute a microbial propagation restraint logic, only when the state described above can be maintained for a predetermined time. In particular, a determination process that is executed when there is low possibility of operation of the automotive air conditioning system, on the basis of the temperature of external air may be provided. Further, as in the previous exemplary embodiment, when an air conditioning system is started again with a microbial propagation restraint logic executed, the process of keeping wind discharged to the floor for a predetermined time with an air conditioner in operation may be provided in the same way.

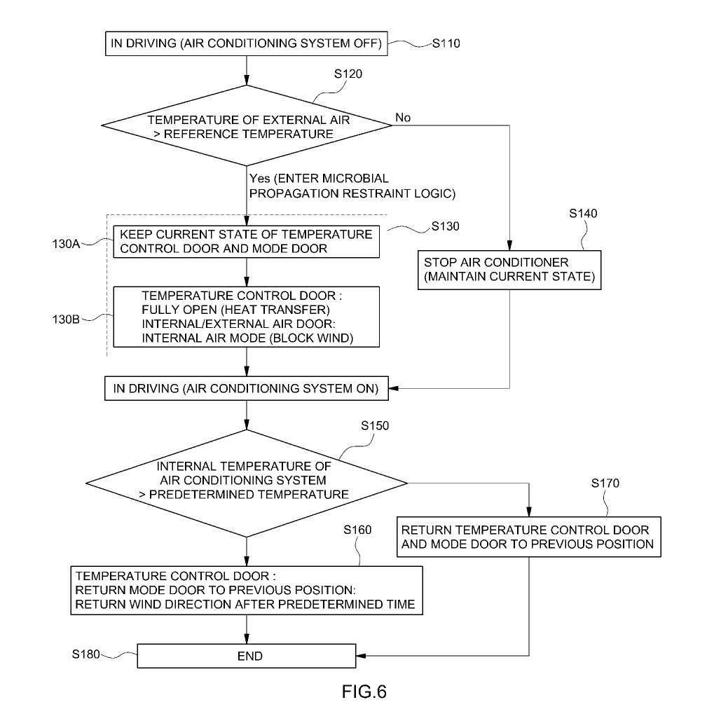

FIGS. 5 and 6 sequentially illustrate a method of restraining microbial propagation on the surface of an evaporator of an automotive air conditioning system according to an exemplary embodiment of the present invention.

Referring to FIG. 5, in the exemplary embodiment, whether an engine has been stopped is sensed (S110), and then when the engine has been stopped, entering a microbial propagation restraint logic for opening a temperature control door disposed between an evaporator and a heater core in an air conditioning system (S130) is performed so that air can flow between the evaporator and the heater core.

The method may further include determining an expected parking time and comparing the determined expected parking time with a predetermined reference time, before the entering of a microbial propagation restraint logic.

In this case, as illustrated in FIG. 5, the temperature control door opens only when the determined expected parking time is over the predetermined reference time, and if not, an air conditioner is stopped and stands by until the engine is restarted and the air conditioner is turned on.

Determining an expected parking time may be achieved in various ways as previously described herein.

The entering of a microbial propagation restraint logic may include keeping the current states of the temperature control door and a mode door in a vehicle and opening the temperature control door. The temperature control door may be fully opened.

In the embodiment, steps such as step S150 and step S180 illustrated in FIG. 5 may be additionally performed to prevent hot and humid air from being discharge to a driver, when an engine is restarted within a short time.

That is, in this embodiment, it is determined whether the evaporator and the heater core have exchanged heat with each other for a sufficient time and the microbial propagation restraint logic has been executed for a sufficient time, on the basis of the internal temperature of the air conditioning system.

Accordingly, as shown in FIG. 5, when the internal temperature of the air conditioning system is over a predetermined temperature, it is considered that hot and humid air is in the air conditioning system, so that the temperature control door is returned to the position before the engine is stopped and the mode door is controlled such that wind is discharged down to the floor.

In contrast, when the internal temperature of the air conditioning system is under the predetermined temperature, it is considered that there is no hot and humid air in the air conditioning system, so that the temperature control door is returned to the position before the engine is stopped and the mode door is also returned to the position before the engine is stopped.

After the temperature control door and the mode door are controlled, the air conditioning system is operated in accordance with user's intention.

Though not illustrated in the drawings, whether the microbial propagation restraint logic has been executed for a sufficient time can be found from the actual parking time. In particular, when a vehicle is restarted within a reference time for the microbial propagation restraint logic, step S160 is performed, thereby achieving the same effects as that of FIG. 5.

Whether to perform step S160 in the present invention depends on whether a sufficient time has been given to restrain microorganisms, but it is not limited to the proposed examples and may be achieved in various ways.

FIG. 6 illustrates an example of implementing a microbial propagation restraint logic while a vehicle is running, as another exemplary embodiment of the present invention.

The exemplary embodiment of FIG. 6 is the same in operation principle as the exemplary embodiment of FIG. 5, but it differs in that since the microbial propagation restraint logic is executed while a vehicle is running, whether to execute the logic depends on whether a controller has turned off an air conditioning system, instead of an engine.

There is another difference in that in order to determine possibility of keeping the logic executed, detecting the temperature of external air and comparing it with a predetermined reference temperature (S220), instead of step S120 relating to an expected parking time, is performed.

Accordingly, as illustrated in FIG. 6, the temperature control door is opened only when the temperature of external air is under a reference temperature (S230B), and if not, only the air conditioner is stopped (S240).

When the microbial propagation restraint logic is performed, keeping the current states of the temperature control door and the mode door (S230A) may be included, and when the temperature control door opens, the internal/external air door may be converted into an internal air mode to block wind (S230B).

When the air conditioning system is turned on again while a vehicle is running, similar to FIG. 5, preventing hot and humid air from being discharged to a driver (S250 to S280) may be performed.

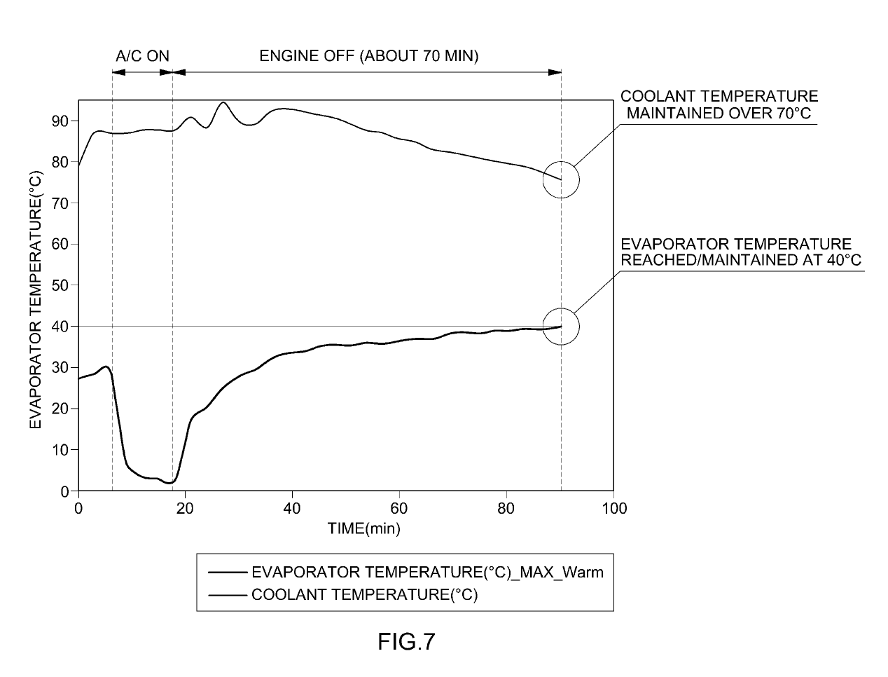

FIG. 7 is a diagram illustrating the result of measuring temperature of an evaporator of an air conditioning system equipped with the apparatus for restraining microbial propagation according to the present invention. In the graph, the upper curve illustrates a coolant temperature and the lower curve illustrates an evaporator temperature.

As illustrated in FIG. 6, the temperature of an evaporator core largely drops in the section (before 20 minutes) with an air conditioner in operation, whereas after an engine is stopped, a temperature control door opens and high-temperature air flow into an evaporator from a heater core, thereby increasing the temperature of the evaporator.

The increasing temperature converges to about 40 degrees enough to thermally damage to microorganisms on the surface of the evaporator in about 70 minutes.

Therefore, according to an apparatus and a method of restraining microbial propagation on the surface of an evaporator of an automotive air conditioning system according to the present invention, since the surface temperature of an evaporator can be increased up to 40 degrees with an engine stopped, it is possible to propagation of microorganisms and reduces a stink accordingly.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An apparatus for restraining microbial propagation on a surface of an evaporator of an automotive air conditioning system of a vehicle, the apparatus comprising:
an evaporator and a heater core disposed in the automotive air conditioning system;
a temperature control door disposed between the evaporator and the heater core so as to selectively block air flowing into the heater core; and
a controller controlling opening/closing of the temperature control door,
wherein when an engine of the vehicle is stopped, the controller opens the temperature control door so that the air can flow between the evaporator and the heater core.

2. The apparatus of claim 1, wherein the controller fully opens the temperature control door when the engine of the vehicle is stopped.

3. The apparatus of claim 1, wherein the controller determines an expected parking time and opens the temperature control door only when the determined expected parking time is over a predetermined reference time.

4. The apparatus of claim 3, wherein the controller receives a parking time from a switch and determines the received parking time as the expected parking time.

5. The apparatus of claim 3, wherein the controller keeps parking time data set for each time zone and determines parking time data for a point of time when the engine is stopped as the expected parking time.

6. The apparatus of claim 3, wherein the controller learns a parking pattern by matching parking time with information such as positions provided from a GPS, a date, and time, and estimates the expected parking time on the basis of the learned parking pattern.

7. The apparatus of any claim 3, wherein when the engine is started again and the automotive air conditioning system is operated within the predetermined reference time, the controller discharges wind down to the floor for a predetermined time.

8. An apparatus for restraining microbial propagation on a surface of an evaporator of an automotive air conditioning system of a vehicle, the apparatus comprising:
an evaporator and a heater core disposed in the automotive air conditioning system;
a temperature control door disposed between the evaporator and the heater core so as to selectively block air flowing into the heater core; and
a controller controlling opening/closing of the temperature control door,
wherein when the automotive air conditioning system is turned off while the vehicle is running, the controller opens the temperature control door so that air can flow between the evaporator and the heater core.

9. The apparatus of claim 8, wherein when the automotive air conditioning system is turned off, the controller converts an internal/external air mode door into an internal air mode.

10. The apparatus of claim 8, wherein the controller receives information on a temperature of external air, and opens the temperature control door only when the temperature of the external air is under a predetermined reference temperature.

11. The apparatus of claim 8, wherein when the automotive air conditioning system is operated again before a predetermined opening time, the controller discharges wind down to the floor for a predetermined time.

12. A method of restraining microbial propagation on the surface of an evaporator of an automotive air conditioning system of vehicle, the method comprising:
sensing whether an engine of the vehicle has been stopped by a controller; and
opening a temperature control door, which is disposed between an evaporator and a heater core in an air conditioning system so that air can flow between the evaporator and the heater core, when the engine is stopped by the controller.

13. The method of claim 12, further comprising:
determining an expected parking time and comparing the determined parking time with a predetermined reference time, by the controller, before the opening of a temperature control door,
wherein in the opening of a temperature control door, the temperature control door opens only when the determined expected parking time is over a predetermined reference time.

14. The method of claim 13, wherein the controller receives a parking time from a switch and determines the received parking time as an expected parking time.

15. The method of claim 13, wherein the controller keeps parking time data set for each time zone and determines parking time data for the point of time when the engine is stopped as the expected parking time.

16. The method of claim 13, wherein the controller learns a parking pattern by matching parking time with information such as positions provided from a GPS, a date, and time and estimates the expected parking time on the basis of the learned parking pattern.

17. The method of claim 13, further comprising:
discharging wind down to the floor for a predetermined time, by the controller, when the engine is started again and the automotive air conditioning system is operated within the predetermined reference time.

18. The method of claim 12, wherein in the opening of the temperature control door, the temperature control door is fully opened.

19. A method of restraining microbial propagation on the surface of an evaporator of an automotive air conditioning system of a vehicle, the method comprising the steps of:
sensing whether an engine of the vehicle has been stopped by a controller; and
opening a temperature control door, which is disposed between an evaporator and a heater core in the automotive air conditioning system so that air can flow between the evaporator and the heater core, when the automotive air conditioning system is turned off while the vehicle is running, by the controller.

20. The method of claim 19, further comprising the step of:
converting an internal/external air mode door into an internal air mode after the automotive air conditioning system is turned off, before the opening of the temperature control door.

21. The method of claim 19, further comprising the step of:
receiving information on a temperature of external air and comparing the received temperature of the external air with a predetermined reference temperature, before the opening of the temperature control door, by the controller,
wherein the temperature control door is opened only when the temperature of the external air is under the predetermined reference temperature.

22. The method of claim 19, further comprising the step of:
discharging wind down to the floor for a predetermined time, by the controller, when the automotive air conditioning system is operated again before a predetermined opening time.
